(19) United States
(12) Patent Application Publication
(10) Pub. No.: US 2020/0256369 A1
(43) Pub. Date: Aug. 13, 2020

(54) Toolless fastener system with multiple locking positions

(71) Applicant: Jin Gao, San Jose, CA (US)

(72) Inventor: Jin Gao, San Jose, CA (US)

(21) Appl. No.: 16/273,239

(22) Filed: Feb. 12, 2019

(51) Int. Cl. F16B 21/07; F16B 21/16

(52) U.S. Cl. CPC F16B 21/073; F16B 21/16

(57) ABSTRACT

Toolless fastener system with multiple locking positions, providing functions of fast fastening and unfastening, as well as adjustable locking position. In addition, the toolless fastener system with multiple locking positions offers toolless methods, so that people don't need to use screw, nut, and screw driver to attach and fasten materials. The toolless fastener system with multiple locking positions allows bearing capacity.

### BACKGROUND OF THE INVENTION

It happens sometimes people don't have suitable fastener tools when people want to attach and detach accessories or ornaments onto bags and wearable goods such as shoes, sweaters, woolen hats, etc. The regular snap fastener cannot attach and fasten thick materials in between because the single stud is short and not adjustable. Thus, the regular snap fastener cannot be used to attach multiple textiles or for similar purposes. The regular snap fastener cannot adjust the locking position either because the rivet snap and fastener socket size are fixed. The regular snap fastener is easy be opened by pulling out the stud, thus the regular snap fastener cannot be used to attach the straps with bags or for similar purposes due to lack of bearing capacity. Some people might use the screw, nut, and screw driver as methods to attach and fasten different materials. The invention of the toolless fastener system with multiple locking positions offers toolless methods. The invention of the toolless fastener system with multiple locking positions, is to provide universal fastener design that people can use it to lock different thickness of materials together. The new invented the toolless fastener system can be easily and quickly fastened and unfastened. The new invented the toolless fastener system with multiple locking positions is designed to bear capacity and providing the connector and locker function of being used to assemble bags and wearable goods.

### SUMMARY OF THE INVENTION

It is desirable to have fastener system that is capable of providing adjustable locking position and toolless features. The present invention provides toolless and adjustable locking structure of fastener.

In one aspect, the structure of fastener is comprising: stud with a plurality of notches as locking positions, tooth and slider structure built in the base kit of fastener wherein said the interior structure of base kit is designed to couple together with notches to secure the fastening. Other features and advantages should be apparent from the following description of various embodiments, which illustrate, by way of example, the principles of the claimed subject matter.

### BRIEF DESCRIPTION OF THE DRAWINGS

FIG. 1 is a front elevational view of decomposition diagram of the toolless fastener system with multiple locking positions, wherein said the stud is inserted through the ornaments or objects, then given fasten on the base of fastener.

FIG. 2 is a top view of decomposition diagram.

FIG. 3 is a bottom view of 102 after installing 201.

FIG. 4 is a top view of 103.

FIG. 5 is a left side plan view of 103.

FIG. 6 is a right side elevational view of 103.

FIG. 7 is a top view of 203.

FIG. 8 is a left side elevational view of 203.

FIG. 9 is a left side elevational view of 204.

FIG. 10 is a right side elevational view of 204.

FIG. 11 is a front elevational view of the toolless fastener system with multiple locking positions which is completely assembled.

FIG. 12 is a left side elevational view of the toolless fastener system with multiple locking positions which is completely assembled.

FIG. 13 is a rear elevational view of the toolless fastener system with multiple locking positions which is completely assembled.

FIG. 14 is a right-side elevational view of the toolless fastener system with multiple locking positions which is completely assembled.

FIG. 15 is a bottom view of the toolless fastener system with multiple locking positions which is completely assembled.

FIG. 16 is a top view of the toolless fastener system with multiple locking positions which is completely assembled.

FIG. 17 illustrates another way to lock and fasten 101 stud, wherein said the stud 101 connected through the base kit to pallet.

FIG. 18 is an alternative base kit that performs locking function as same as 103.

FIG. 19 is a left side elevational view of the alternative base kit of toolless fastener system. 105 is at locking position in FIG. 19.

FIG. 20 is a top plan view of the alternative base kit of toolless fastener system.

FIG. 21 is a right-side elevational view of the alternative base kit of toolless fastener system.

FIG. 22 is a right-side elevational view of 105.

FIG. 23 is a left side elevational view of 105.

FIG. 24 is a front elevational view of 104.

FIG. 25 is a right side elevational view of 104.

FIG. 26 is a left side elevational view of 104.

FIG. 27 is a left side elevational view of decomposition diagram of 104 and 105.

FIG. 28 illustrates base kit 600 similar like 103 but using for heavy duty variant.

FIG. 29 is a bottom view of 500. 502 503 are the same screws as 201. They perform the same function as 201. 501 is a column on the backside of 500 that is designed to limit and control the movements of 504.

FIG. 30 is decomposition diagram of 600.

FIG. 31 is a left side elevational view of 504 and 5040.

FIG. 32 is a right side elevational view of 504 and 5040.

FIG. 33 is a back side elevational view of 504 and 5040.

FIG. 34 is a bottom view of 504 and 5040.

FIG. 35 is a right side elevational view of 505. 510 is a column 505 that is designed to limit and control the movements of 5040.

FIG. 36 is a left side elevational view of 505.

FIG. 37 is a front elevational view of 505.

FIG. 38 is a top view of decomposition diagram of 600.

FIG. 39 illustrates how to install the 506 after 504 is installed.

FIG. 40 illustrates how to install 500 onto 600.

FIG. 41 is a top view of 500 and 600.

FIG. 42 is a top view of the toolless fastener system with multiple locking positions which is completely assembled. 101 inserts through 600 to 500.

FIG. 43 is a front elevational view of the toolless fastener system with multiple locking positions which is completely assembled. 101 inserts through 600 to 500.

FIG. 44 is a front elevational view of the toolless fastener system with multiple locking positions which is completely assembled. 101 inserts through 500 to 600.

FIG. 45 is a top view of the toolless fastener system with multiple locking positions which is completely assembled. 101 inserts through 500 to 600.

### DETAILED DESCRIPTION OF THE INVENTION

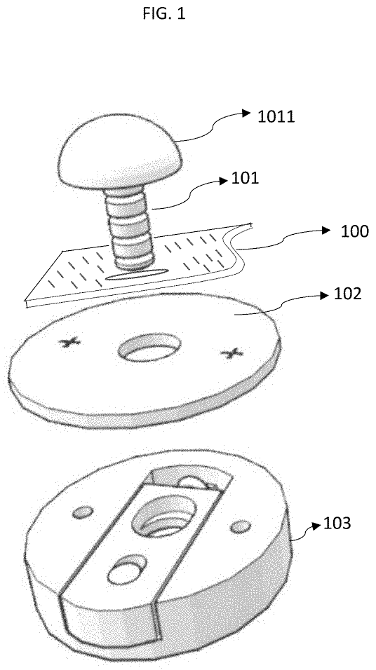

The present invention is toolless fastener system with multiple locking positions. FIG. 1 101 is a stud with multiple notches as locking positions. 1011 is the cap of 101. 1011 can be any colors, shapes or patterns. 102 is a pallet with three holes and two screws. 101 inserts into ornaments or objects 100, then inserts through the middle hole of 102. 103 is the base kit of the toolless fastener system. Ornaments or objects 100 are attached between 101 and 102.

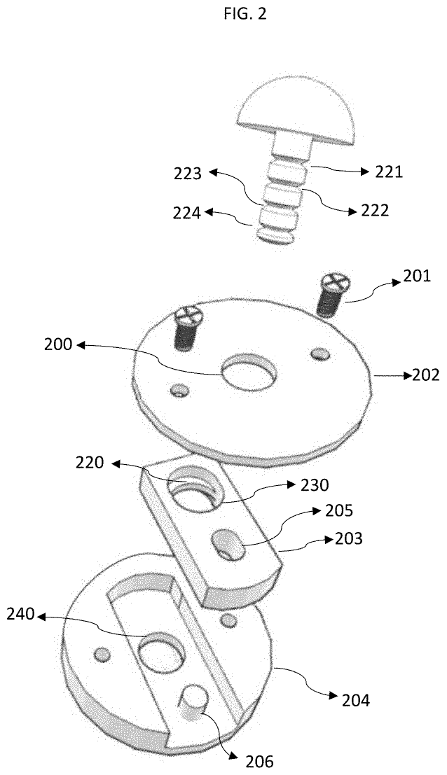

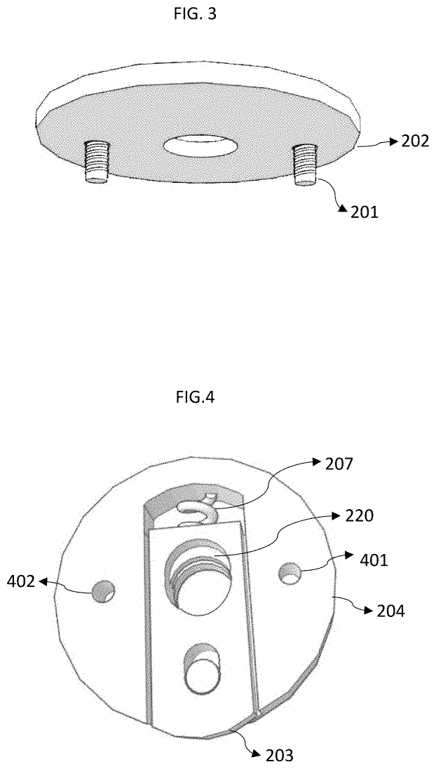

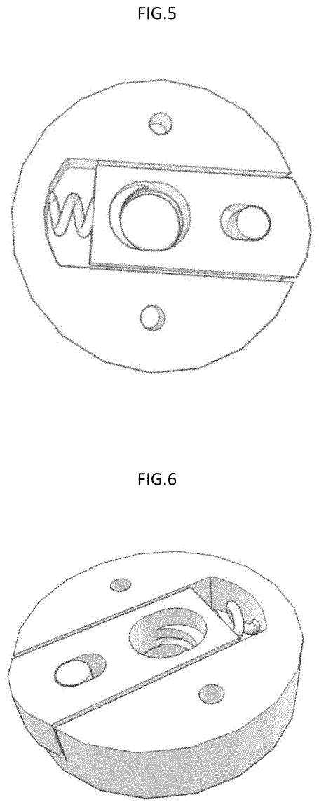

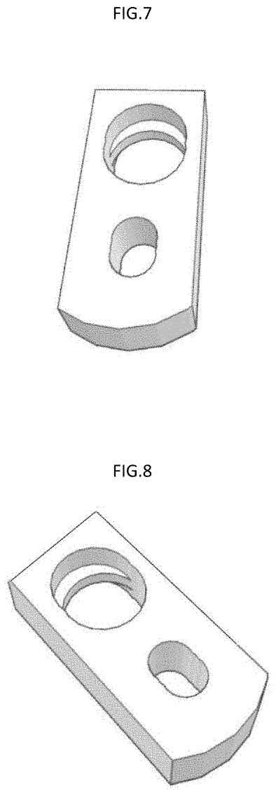

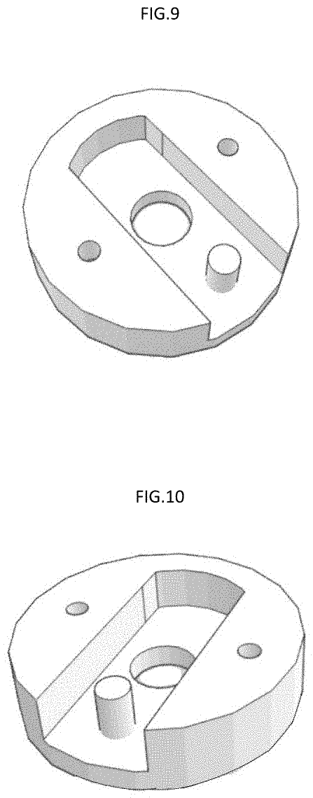

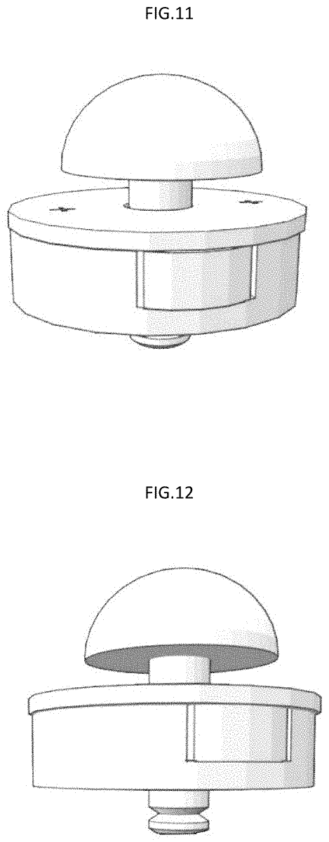

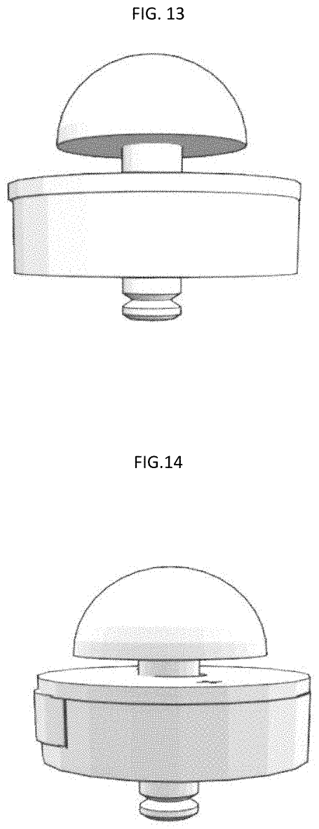

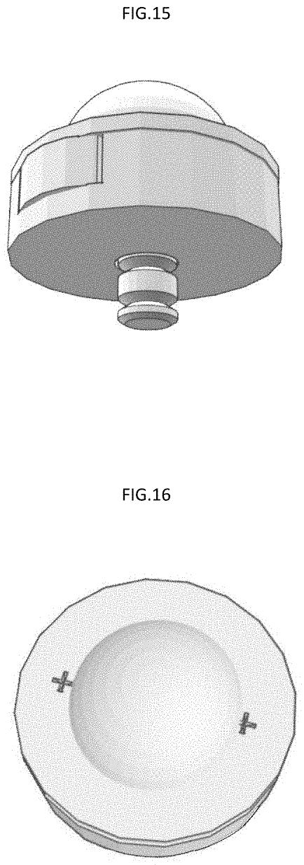

As best shown in FIG. 2, 102 consists of screw 201 and pallet 202. 200 is the middle hole of 102. 101 stud has multiple notches as locking positions of 221 222 223 224. Insert 101 through 200, then insert through 230. 203 is a slider. 220 is a tooth inside the 230. 220 is used to lock 101 at the different positions 221 222 223 224. 101 lock position is depending on the thickness of 100. In order to install 203 onto 204, 205 hole needs to buckle into 206 column. 206 is a column on 204 that can be used to limit and control the movements of 203. 240 is a hole on the base of 204. When 220 locks at 221 and 222, the tip of 101 will pass through 240.

As further shown in FIG. 4, 103 consists of the slider 203, the base 204 and the spring 207. 207 is used to push the slider 203 to its lock position when no external force is applied to the slider. 203 is at the position of releasing lock in FIG. 4. 401 402 are the holes on the 204. 201 screw inserts and installs into 401, then 102 can be fastened onto 204. When slider 203 is not pressed from outside, it will be pushed by spring 207 against stud 101 and its tooth 220 will latch into the notch of 101 so to lock the position of 101. When slider 203 is pressed, it will move away from the stud 101 and its tooth 220 will be moved out of the notch of stud 101, so to release the stud from its locking position.

The toolless fastener system provides stud two ways of locking, wherein said stud inserts from the side of pallet to side of base kit, or side of base kit to side of pallet. FIG. 17 illustrates stud mating with base kit first, then through pallet to give fasten, inserting FIG. 2 101 through hole 240 of 204, then through hole 230 of 203, then through hole 200 of 102, the toolless fastener locking system works the same.

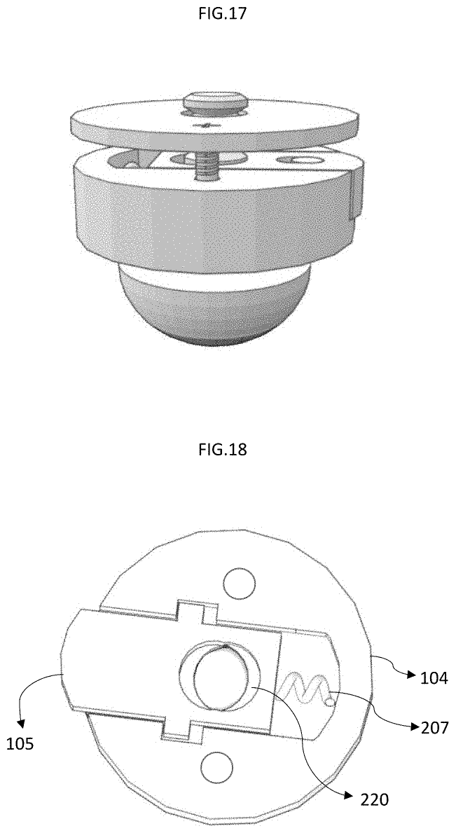

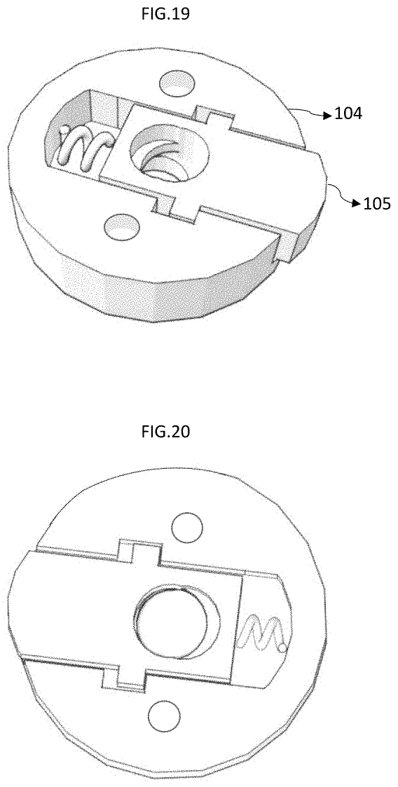

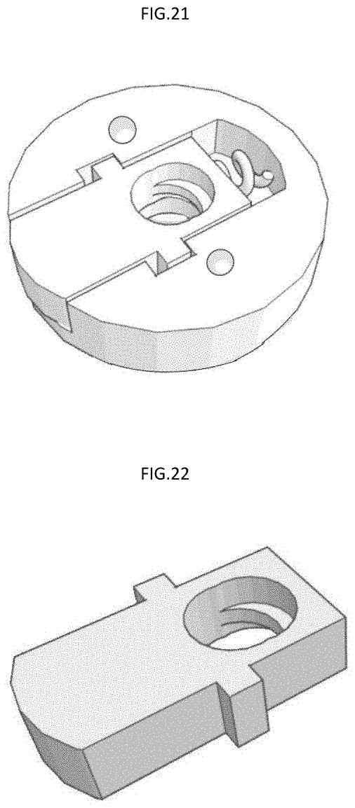

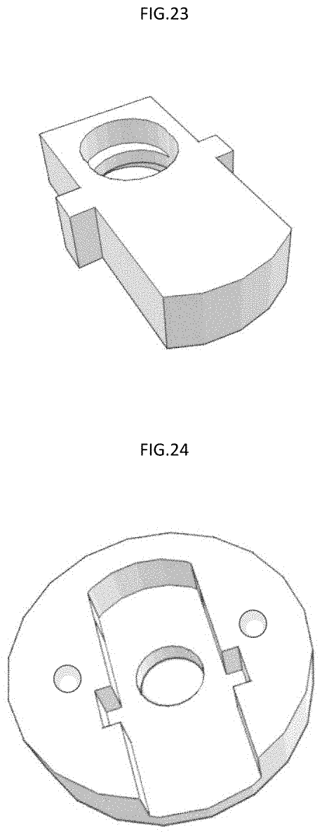

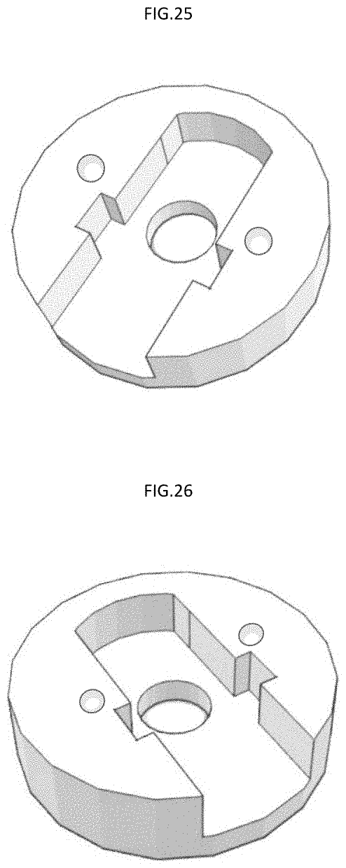

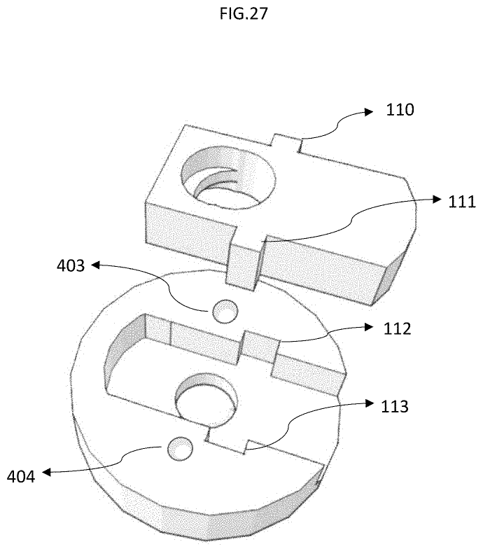

In order to provide same locking function, FIG. 18 illustrates a slider 105 with wings. 104 is a base with wings that is designed to limit and control the movements of 105. Spring 207 is used to push the slider 105 to its lock position when no external force is applied to the slider. When slider 105 is not pressed from outside, it will be pushed by spring 207 against stud 101 and its tooth 220 will latch into the notch of stud 101 so to lock the position of 101. When slider 105 is pressed, it will move away from the stud 101 and its tooth 220 will be moved out of the notch of stud 101, so to release the stud from its locking position. FIG. 27 wings 110 111 of 105 buckle into 112 113 of 104. 403 404 are the holes on the 104. 403 404 are the same as 401 402. 201 screw inserts and installs into 403, then 102 can be fastened onto 104.

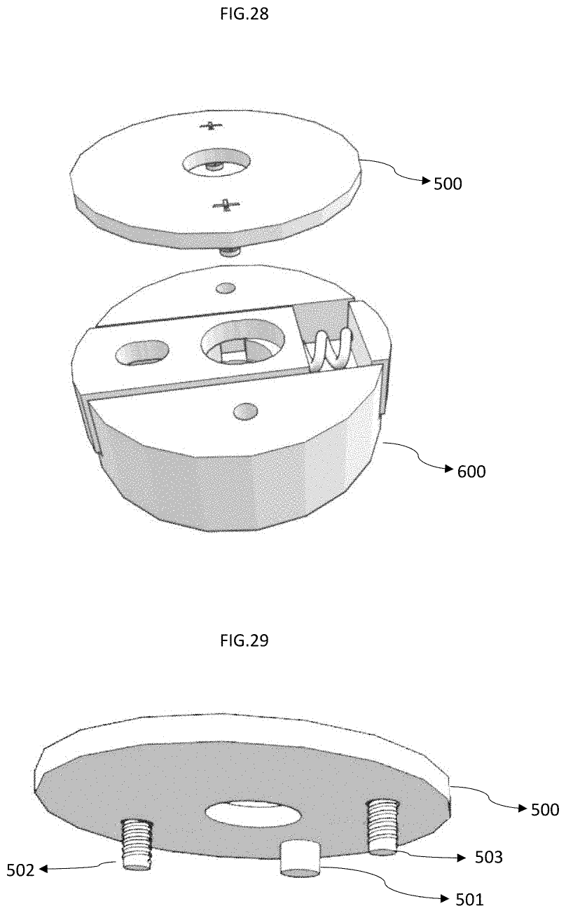

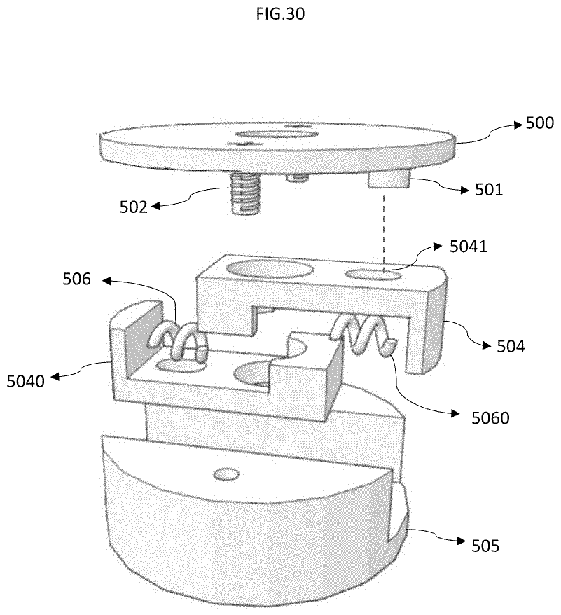

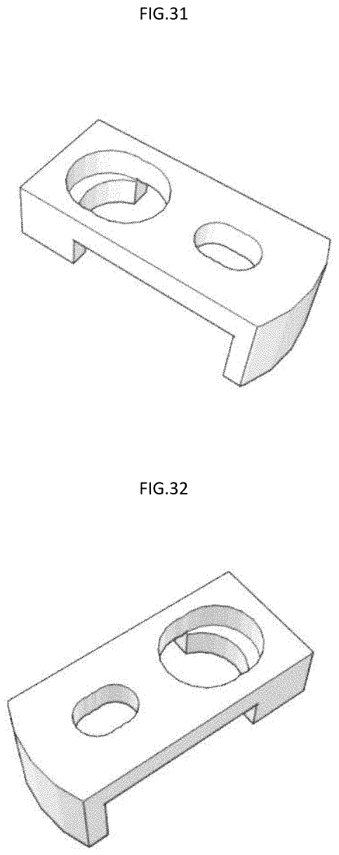

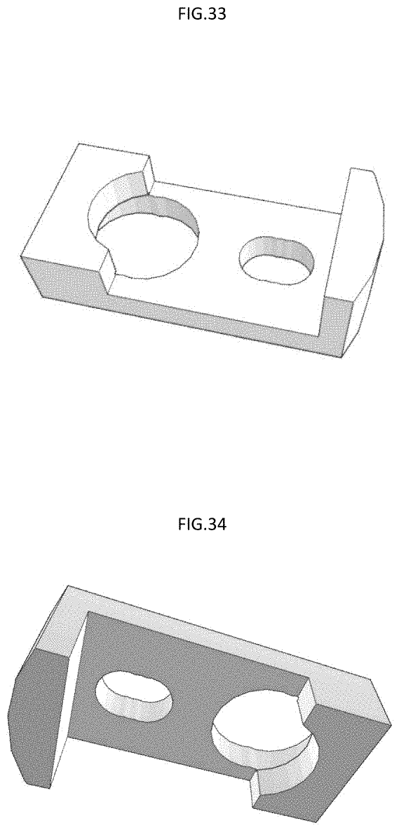

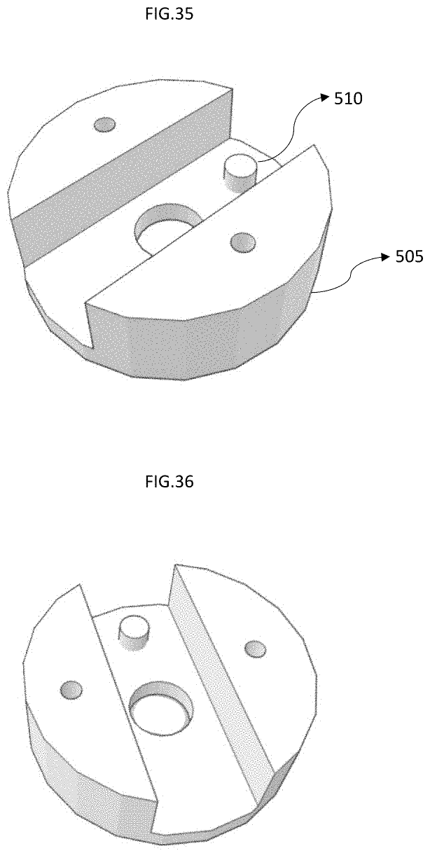

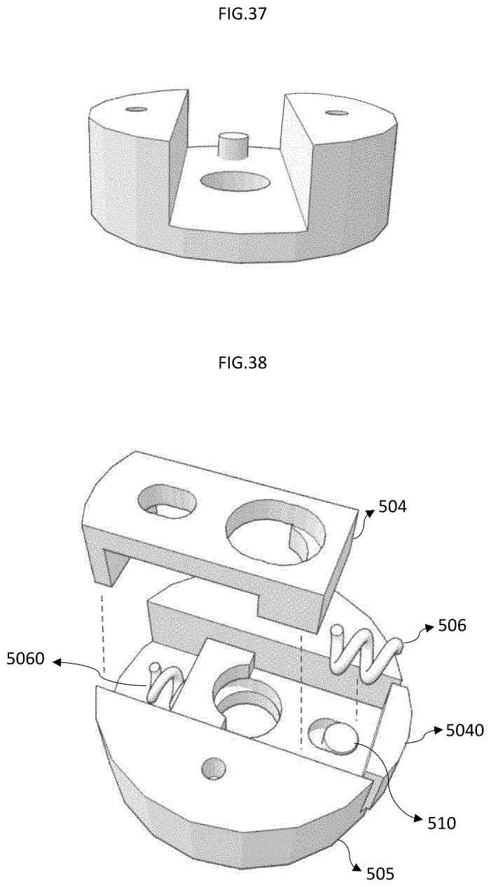

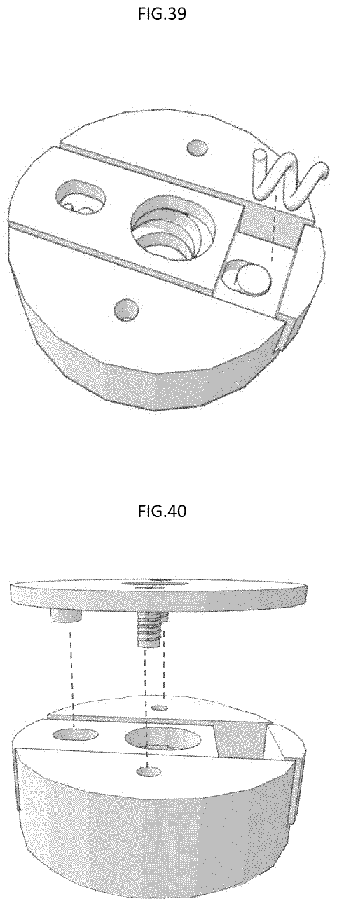

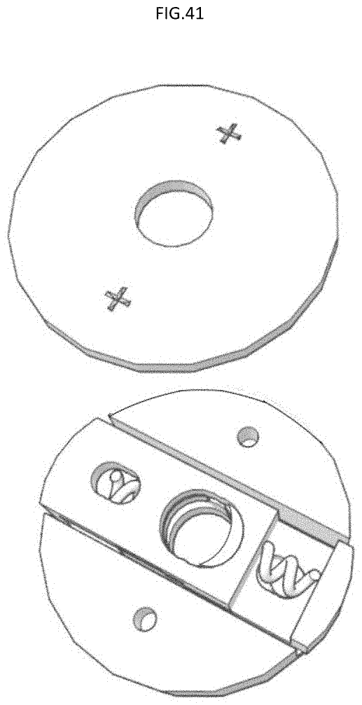

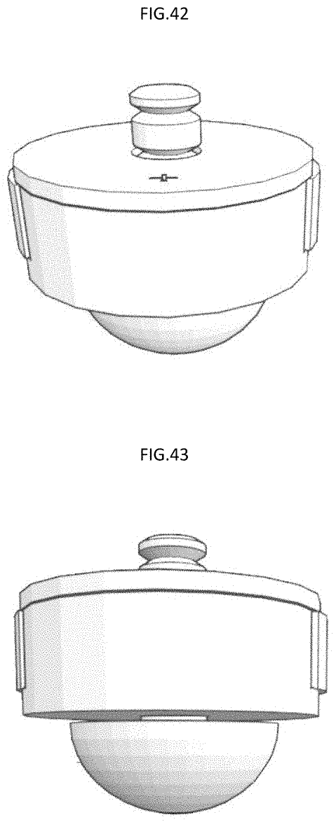

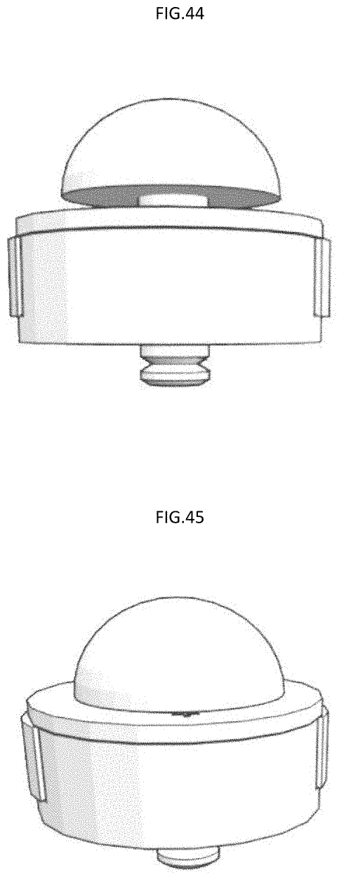

As further shown in FIG. 28 and 30, in order to provide heavy duty variant, 500 is the pallet attached to 600. The heavy duty base kit 600 also uses 101 as stud of the toolless fastener locking system. 600 consists of two sliders so that it can support heavy duty when applying the locking system to bear capacity and hold heavy materials. FIG. 28 600 consists of FIG. 30 504 5040 506 5060 505. 504 and 5040 are the same sliders. 506 and 5060 are the same springs which are used to push 504 and 5040 to lock position when no external force is applied to the sliders. 505 is the base of the heavy duty base kit. 5041 has the same function as 205. 5041 hole needs to buckle into 501 column. Furthermore, as illustrating in FIG. 38, 600 consists of 506 5060 504 5040 505. The dot line illustrates how to install the 506 and 504. 506 5060 are the same springs. The teeth inside 504 and 5040 can lock stud 101 at different positions. The double teeth can support heavy duty when applying the locking system to bear capacity. When slider 504 5040 are not pressed from outside, they will be pushed by spring 506 5060 against stud 101 and the teeth of 504 5040 will latch into the notch of 101 so to lock the position of 101. When slider 504 5040 are pressed, they will move away from the stud 101 and the teeth of 504 5040 will be moved out of the notch of stud 101, so to release the stud from its locking position.

What I claim is:

1. Toolless fastener system with multiple locking positions, as set forth in the following specification. The invention of the toolless fastener system with multiple locking positions is used for easily attaching and fastening ornaments onto bags and wearable goods. The invention of the toolless fastener system can bear capacity and it can be used to assemble bags and wearable goods. The toolless fastener system consists of stud with cap and multiple notches, pallet, screws, slider with tooth, base, and springs.

2. As claimed in claim 1, the toolless fastener system with multiple locking positions is also used for similar purposes of snap fasteners.

3. As claimed in claim 1, the toolless fastener system with multiple locking positions allows quickly fastening and unfastening.

4. As claimed in claim 1, the stud of the toolless fastener system with multiple locking positions consists of cap and multiple notches. The cap of the stud can be any shapes or patterns.

5. As claimed in claim 1, the toolless fastener system with multiple locking positions allows locking at different positions, which means people can adjust the fastening position based on the thickness of the objects that need to be attached together.

6. As claimed in claim 1, when slider is not pressed from outside, it will be pushed by spring against stud and the tooth of slider will latch into the notch of stud so to lock the position of stud. When slider is pressed, it will move away from the stud and the tooth of slider will be moved out of the notch of stud, so to release the stud from its locking position.

7. As claimed in claim 1, the invention of toolless fastener system that allows multiple locking positions, is to provide universal fastener design that people can use it to lock different thickness of materials together while locking position is adjustable.

8. Instead of using screw, nut, and screw driver as methods to attach and fasten different materials, as claimed in claim 1, the invention of the toolless fastener system with multiple locking positions offers toolless methods.
